(19) United States
(12) Patent Application Publication
(10) Pub. No.: US 2016/0343306 A1
(43) Pub. Date: Nov. 24, 2016

(54) IMAGE DISPLAY DEVICE AND IMAGE DISPLAY METHOD

(71) Applicant: TOSHIBA TEC KABUSHIKI KAISHA, Tokyo (JP)

(72) Inventor: Katsuya Sasahara, Izu (JP)

(21) Appl. No.: 15/229,239

(22) Filed: Aug. 5, 2016

Related U.S. Application Data
(62) Division of application No. 14/640,099, filed on Mar. 6, 2015.

(51) Int. Cl. G09G 3/34; G06F 21/60

(52) U.S. Cl. CPC G09G 3/344; G06F 21/604; G09G 2358/00; G09G 2360/144

(57) ABSTRACT

According to an embodiment, an image display device includes an image display unit, an optical sensor, and a control unit. The image display unit displays an image on a display screen using a display mechanism in which scanning is optically possible in a copy machine. The optical sensor is arranged on a plane including the display screen, and detects brightness of light with which the display screen is irradiated. The control unit changes display contents on the display screen to a predetermined display state when it is detected that the brightness of light with which the display screen is irradiated is at a predetermined threshold value or more in the optical sensor.

### CROSS-REFERENCE TO RELATED APPLICATIONS

This application is a Division of application Ser. No. 14/640,099 filed on Mar. 6, 2015, the entire contents of which are incorporated herein by reference.

### FIELD

Embodiments described herein relate generally to a portable image display device, and an image display method in the portable image display device.

### BACKGROUND

In the related art, among portable image display devices such as a mobile tablet, since electronic paper is a display mechanism through which a display screen is viewed using reflected light, similarly to paper, for example, it is possible to perform copying or scanning in a copy machine, or the like. Accordingly, there is a problem in that, when electronic data is displayed on a display device such as electronic paper which can be subjected to copying, the electronic paper can be easily copied using a copy machine, or the like, even if it is possible to prohibit copying of the electronic data itself.

### DESCRIPTION OF THE DRAWINGS

FIG. 1 is a diagram which illustrates the appearance of an image display device according to a first embodiment.

FIG. 2 is a block diagram which illustrates a hardware configuration of the image display device in FIG. 1.

FIG. 3 is a diagram which illustrates an image reading device which is used when scanning an image displayed in the image display device.

FIG. 4 is a schematic diagram of an image reading unit in the image reading device in FIG. 3.

FIG. 5 is a flowchart which illustrates a flow of a scanning prohibiting operation of an image displayed in the image display device.

FIG. 6 is a diagram which illustrates a threshold value of brightness which is detected by an optical sensor.

FIG. 7 is a diagram which illustrates a state in which display content of the image display device is changed to a predetermined display state.

FIG. 8 is a diagram which illustrates a state in which a warning display image is displayed on a display screen of the image display device.

FIG. 9 is a diagram which illustrates a state in which the image display device and an external device are connected through a network.

FIG. 10 is a diagram which exemplifies information related to the image display device or a user of the image display device which is transmitted to the external device.

FIG. 11 is a block diagram which illustrates a hardware configuration of an image display device according to a second embodiment.

FIG. 12 is a flowchart which illustrates a flow of a scanning prohibiting operation in the image display device according to the second embodiment.

FIG. 13 is a block diagram which illustrates a hardware configuration of an image display device according to a third embodiment.

FIG. 14 is a diagram which illustrates the appearance of the image display device according to the third embodiment.

FIG. 15 is a flowchart which illustrates a flow of a scanning prohibiting operation in the image display device according to the third embodiment.

FIG. 16 is a block diagram which illustrates a hardware configuration of an image display device according to a fourth embodiment.

FIG. 17 is a flowchart which illustrates a flow of a scanning prohibiting operation in the image display device according to the fourth embodiment.

### DETAILED DESCRIPTION

According to an embodiment, an image display device includes an image display unit, an optical sensor, and a control unit. The image display unit displays an image on a display screen using a display mechanism in which scanning is optically possible in a copy machine. The optical sensor is arranged on a plane including the display screen, and detects brightness of light with which the display screen is irradiated. The control unit changes display contents on the display screen to a predetermined display state when it is detected that brightness of light with which the display screen is irradiated is at a predetermined threshold value or more in the optical sensor.

### First Embodiment

A first embodiment is related to an image display device in which it is possible to prevent copying of an image using a copy machine, or the like, with respect to an image displayed in the image display device. When copying is performed using a copy machine, or the like, the image display device is placed on a glass plate of the copy machine, or the like, by causing a face (display screen) on which an image is displayed to face downward. In addition, the display screen is irradiated with scanning light from the copy machine, or the like. According to the embodiment, the image display device detects that the display screen faces downward, and the display screen is irradiated with strong light, and changes contents of an image displayed on the display screen.

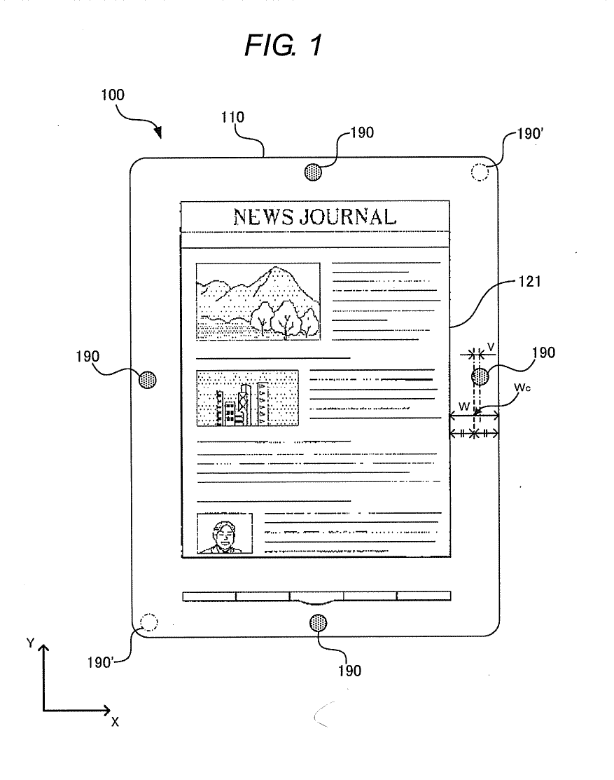

FIG. 1 is a diagram which illustrates the appearance of an image display device 100 according to the first embodiment.

First, the appearance of the image display device 100 according to the embodiment will be described. Here, an X axis and a Y axis in FIG. 1 are orthogonal to each other.

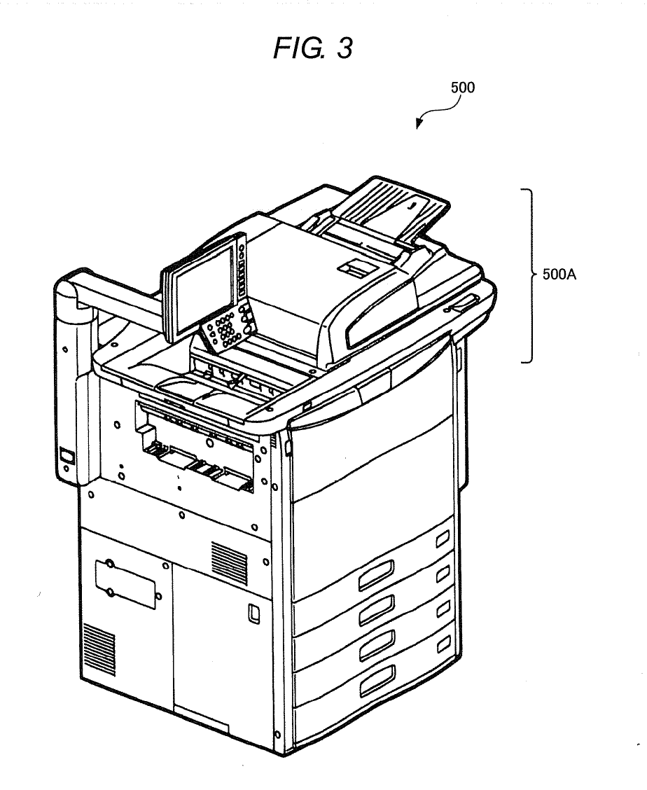

As illustrated in FIG. 1, the image display device 100 according to the embodiment is a so-called tablet image display device, and includes a housing 110, a display screen 121 which displays characters, images, and other content, and an optical sensor 190 which detects brightness of light with which the display screen 121 is irradiated. Here, the image display device 100 is not necessarily a tablet image display device, and may be an image display device of which an image can be read in a copy machine 500 (refer to FIG. 3).

It is possible to adopt electronic paper which is a sheet-shaped display device for the display screen 121 which is provided in the image display device 100. The electronic paper is a medium in which display content can be electrically rewritten among display mediums which have visibility or portability which are good points of paper. Since the electronic paper is a display mechanism in which a display image is visible using reflected light from a display surface similarly to paper, copying or scanning is possible in a copy machine, or the like. However, according to the embodiment, the electronic paper is not necessarily adopted in the display screen 121. When it is a display screen 121 of which an image can be read, which is irradiated with light, and can be scanned in the copy machine 500, the display screen may be a display device in which any display mechanism is adopted.

In addition, the light receiving position of the optical sensor 190 is on a plane including the display screen 121 in the image display device 100, and the optical sensor is arranged at the periphery of the display screen 121. As illustrated in FIG. 1, according to the embodiment, four light receiving positions are provided at the periphery of the display screen 121. In FIG. 1, two of the four light receiving positions are respectively provided at an intermediate position of the image display device 100 (face including display screen 121) in the Y direction, and at both end portions of the image display device 100 in the X direction (face including display screen 121) one by one. The other two light receiving positions are respectively provided at the intermediate position of the image display device 100 (face including display screen 121) in the X direction, and at both end portions of the image display device 100 (face including display screen 121) in the Y direction.

In addition, it is preferable that the processing time from detecting scanning light which is radiated at the time of performing a scanning process until changing of display content is secured as long as possible. Accordingly, it is preferable that light receiving positions of the optical sensor 190 are provided at both end portions of the image display device 100, respectively, one by one in the Y direction, and respective light receiving positions are separated from each other in the Y direction as much as possible. In addition, it is preferable that the light receiving positions are also provided at both ends of the image display device 100, one by one in the X direction, and the respective light receiving positions are separated from each other in the X direction as much as possible. By doing so, it is possible to ensure that a processing time from detecting irradiation of light by the optical sensor 190 until changing of display content is secured as long as possible, even when scanning light with which the display screen 121 is irradiated goes toward any of the X direction, the Y direction, a direction reverse to the X direction, and a direction reverse to the Y direction. For example, according to the embodiment, at a light receiving position of the optical sensor 190 which is located at the farthest side in the X direction, the light receiving position is arranged on the X direction side by a length V compared to an intermediate position Wc of the length W in the X direction in a region other than the display screen 121.

In addition, as illustrated in FIG. 1, two light receiving positions using the optical sensor may be provided at diagonal positions on a plane including the display screen 121 in the image display device 100. In FIG. 1, light receiving positions of optical sensors 190′ are provided at such diagonal positions. By arranging the light receiving positions of the optical sensors 190′ in this manner, it is possible to secure a long processing time from detecting of light irradiation using the optical sensor 190′ to changing of display content using only two light receiving positions.

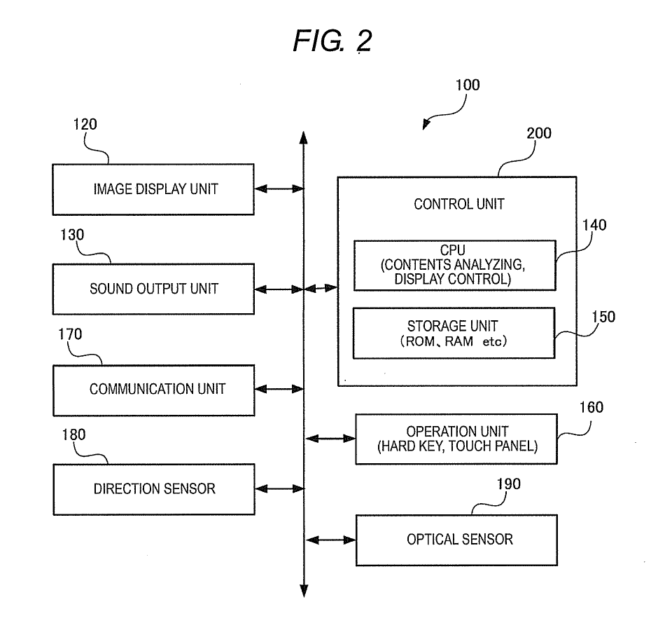

FIG. 2 is a block diagram which illustrates a hardware configuration of the image display device in FIG. 1.

As illustrated in FIG. 2, the image display device 100 according to the first embodiment includes an image display unit 120, a sound output unit 130, a control unit 200, an operation unit 160, a communication unit 170, a direction sensor 180, and the optical sensor 190. The control unit 200 includes a CPU 140 and a storage unit 150.

The image display unit 120 displays an image on the display screen 121 using a display mechanism which can be optically scanned by a copy machine. As described above, as the display screen 121, electronic paper is adopted, for example.

The sound output unit 130 is configured of a speaker, a sound output terminal, or the like, for example, and is configured so that sound is output based on a sound signal. Outputting of sound from the sound output unit 130 is controlled by the control unit 200.

The control unit 200 is configured so as to control operations of the image display device 100, and according to the first embodiment, the control unit 200 performs control of a display of information with respect to the image display unit 120, an output control of sound from the sound output unit 130, and a control corresponding to an input operation of a user using the operation unit 160.

The storage unit 150 is configured of a Read Only Memory (ROM), a Random Access Memory (RAM), an Electrically Erasable Programmable Read-Only Memory (EEPROM), or the like, and stores a computer program which is used when performing various controls using the control unit 200, or various data generated when executing the computer program. The computer program which is read from the storage unit 150 is read using the control unit 200, and is sequentially executed.

The operation unit 160 receives operations with respect to the image display device 100 from a user of the image display device 100. The operation unit 160 may be configured of, for example, a keyboard, buttons, or the like, or may be configured of a touch panel.

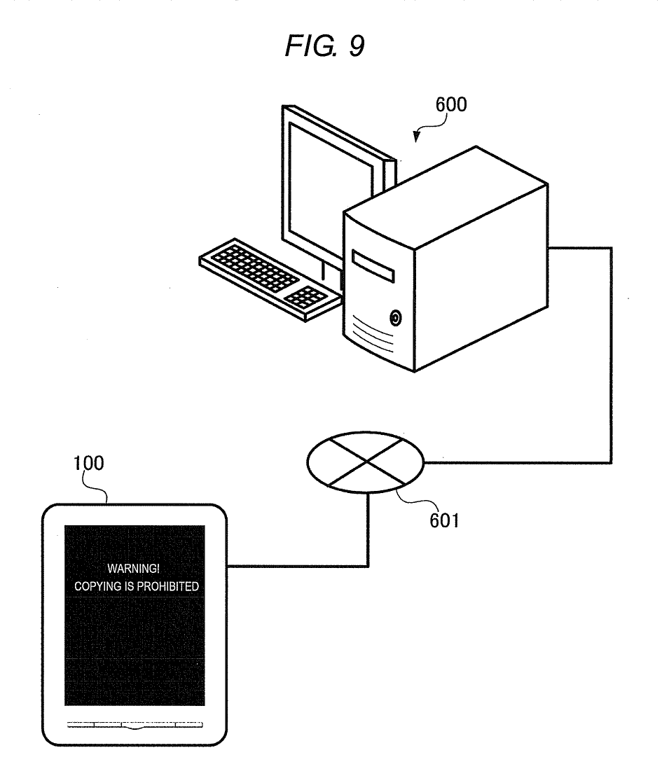

The communication unit 170 is configured of a device which executes a communication process between the image display device 100 and an external device 600 (refer to FIG. 9) which is connected to the image display device through a network 601 (refer to FIG. 9). In the image display device 100, it is possible to display contents on the display screen 121 by obtaining the contents from the external device 600, for example, by executing communication with the external device 600 which is connected through the network 601 using the communication unit 170.

The direction sensor 180 can detect the direction which the display screen 121 is facing. Here, as the direction sensor 180, it is possible to adopt an acceleration sensor such as a Micro Electro Mechanical Systems (MEMS) sensor which detects the direction of gravitational acceleration, or an angular velocity sensor such as a gyro sensor. In addition, it is also possible to adopt a mechanical direction sensor of a pendulum type which is turned on only when the display screen 121 faces downward, or the like, without being limited to these types. In addition, facing downward is not limited only to facing downward, vertically, and denotes facing downward, substantially vertically.

The optical sensor 190 is provided on a plane including the display screen 121 in the image display device 100. The optical sensor 190 is a sensor which detects electromagnetic energy such as light, and can detect brightness of light with which the display screen 121 is irradiated. Here, in measuring the brightness of the light, it is possible to adopt various units such as luminance (candela: [cd]), light flux (lumen: [lm]), illuminance (lux: [lx]); however, there is no limitation to these, and as a result, a parameter may be used by which it is possible to grasp the brightness of light with which a display surface is irradiated, it is also possible to adopt a voltage value or a current value which is generated when detecting light in the optical sensor as a determination parameter of “brightness”, for example. In addition, as a threshold value of brightness here, specifically, it is possible to adopt a lower limit value, or the like, of usual brightness of scanning light with which the display screen of the image display device is irradiated when the display screen of the image display device is copied in a copy machine, for example.

FIG. 3 is a diagram which illustrates the copy machine 500 which is used when scanning an image displayed on the display screen 121 in the image display device 100.

Since electronic paper performs display using reflected light, similarly to paper, it is possible to perform scanning comparatively easily using the copy machine 500 as illustrated in FIG. 3. When performing scanning in the copy machine 500, an image is read using an image reading unit 500A of the copy machine 500.

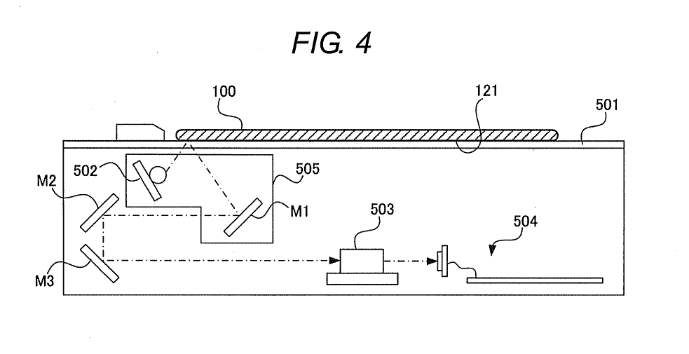

FIG. 4 is a schematic view of the image reading unit 500A in the copy machine 500 in FIG. 3.

A mechanism of the image reading unit 500A in which an image displayed on the display screen 121 in the image display device 100 is scanned will be simply described.

The image reading unit 500A includes a document table glass plate 501, a light source 502, a lens 503, a CCD 504, a carriage 505, and mirrors M1, M2, and M3.

When a user scans the display screen 121 of the image display device 100, the display screen 121 is placed on the document table glass plate 501 facing downward. In addition, the display screen 121 of the image display device 100 which is placed on the document table glass plate 501 is irradiated with light which is radiated from the light source 502.

The light from the light source 502 with which the display screen 121 is irradiated is reflected, is reflected on the mirrors M1, M2, and M3 thereafter, and passes through the lens 503. The light which passes through the lens 503 is condensed in the CCD 504, the light condensed in the CCD 504 is subjected to photoelectric conversion, is replaced by an electric signal, is converted into a digital signal thereafter, and the digital signal is output to a control board (not illustrated). In addition, the carriage 505 moves the light source 502 and the mirror M1 integrally in the sub-scanning direction. In this manner, an image displayed on the display screen 121 is read as image data using the image reading unit 500A.

In this manner, when it is desired to scan an image displayed on the display screen 121, the display screen 121 in a state of facing downward is irradiated with light. The image display device 100 according to the first embodiment prevents an image displayed on the display screen from being scanned in a copy machine, by detecting that the display screen 121 faces downward, and the display screen 121 is irradiated with light with brightness of a threshold value or more.

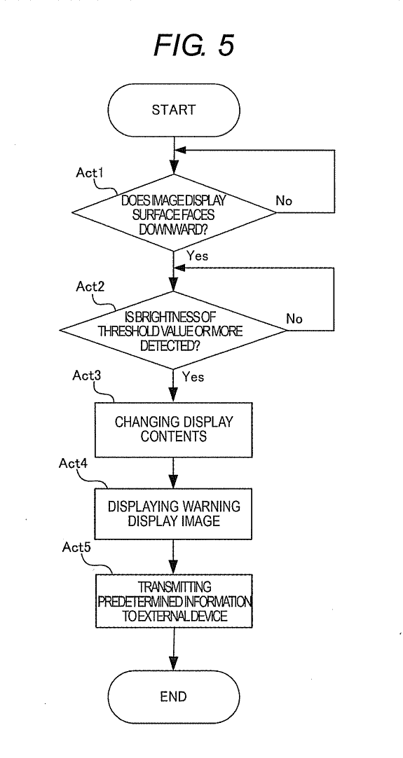

FIG. 5 is a flowchart which illustrates a flow of operations for prohibiting scanning of an image displayed on the display screen 121.

In Act 1, when the direction sensor 180 detects that the display screen 121 faces downward, the process proceeds to Act 2 (Yes in Act 1). On the other hand, when the direction sensor 180 does not detect that the display screen 121 faces downward in Act 1, the process does not proceed to Act 2 (No in Act 1). In general, when an original document of a book, or the like, is scanned by pressing the original document onto the document table glass plate, a reading face of the original document is in a state of facing downward. Therefore, according to the first embodiment, it is possible to more accurately grasp a situation in which a scanning process, or the like, is attempted, by creating a situation in which the display screen 121 of the image display device 100 faces downward as one of determination standards when determining that a copying or scanning process is attempted in the copy machine.

In Act 2, when the optical sensor 190 detects that brightness of light with which the display screen 121 is irradiated has a predetermined threshold value or more, the process proceeds to Act 3 (Yes in Act 2). On the other hand, in Act 2, when the optical sensor 190 does not detect that the brightness of light with which the display screen 121 is irradiated has a predetermined threshold value or more, the process does not proceed to Act 3 (No in Act 2).

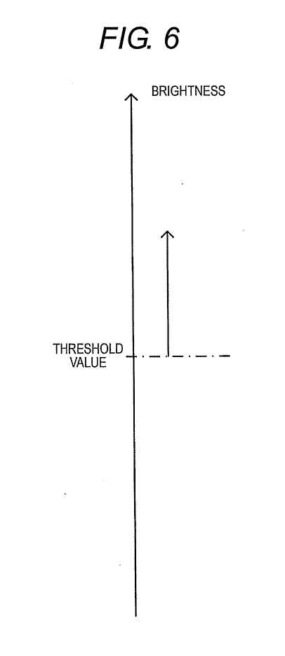

FIG. 6 is a diagram which illustrates a threshold value of brightness of light with which the display screen 121 is irradiated which is detected by the optical sensor.

As illustrated in FIG. 6, when a predetermined threshold value of brightness is set in advance, and brightness in the display screen 121 exceeds the threshold value, the process proceeds to Act 3. The threshold value of brightness is described above.

In Act 3, when the control unit 200 controls the image display unit 120, the image display unit 120 changes display contents which are displayed on the display screen 121 to be in a predetermined display state. In this manner, scanning of the display screen 121 using the copy machine 500 is prevented.

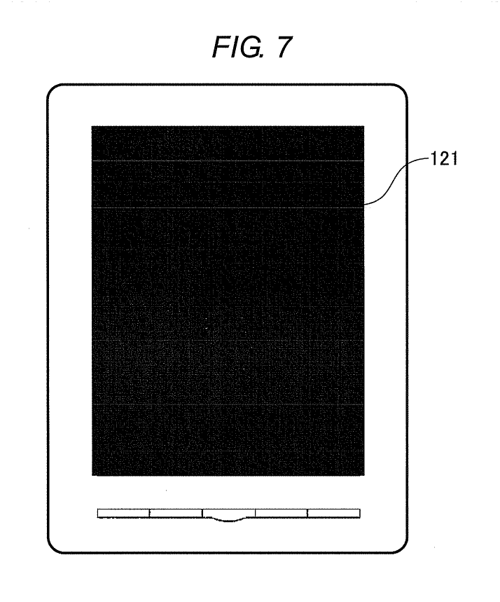

FIG. 7 is a diagram which illustrates a state in which display contents of the display screen 121 in the image display device 100 are in a predetermined display state.

FIG. 7 illustrates the display screen 121 when display contents on the display screen 121 are changed to a black color. In this state, only the black display screen 121 is scanned even when the display screen 121 is scanned in the copy machine 500 in such a state, and it is possible to prevent a confidential document, or the like, from being scanned.

Here, changing display contents of the display screen 121 to a predetermined display state means not only a case in which an image which is currently displayed (display contents) is merely switched to another predetermined image, but for example, also includes a state in which an image display is not performed at all, or a case in which an image on the entire display surface is painted over using one color or a plurality of colors, an image which is disturbed using a predetermined algorithm (for example, being changed into mosaic, or the like), or the like. In this manner, according to the first embodiment, it is possible to prevent display contents from being scanned by changing the display contents, when the image display device 100 which adopts a display mechanism which is possible to be scanned in a copy machine receives strong scanning light due to a scanning process in the copy machine.

In Act 4, when the control unit 200 controls the image display unit 120, the image display unit 120 changes an image displayed on the display screen 121 to a warning display image. Here, the warning display image is, for example, an image which issues a warning prohibiting scanning to a user who tries to scan a document which is protected by a copyright, a confidential document, or the like.

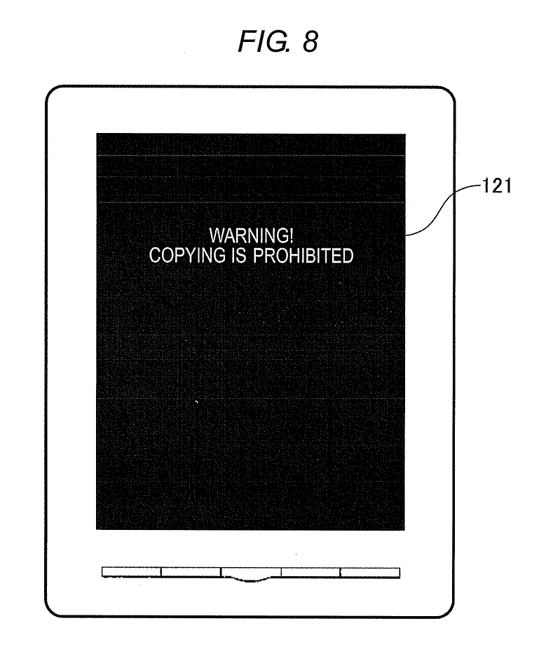

FIG. 8 is a diagram which illustrates a state in which a warning display image is displayed on the display screen 121 of the image display device 100.

In FIG. 8, as the warning display image, a text “Warning! Copying is prohibited” is displayed. Here, the warning display image is not limited to the text “Warning! Copying is prohibited”, and for example, may be an animated image for promoting prohibition of scanning with respect to an image displayed on the display screen 121. That is, the warning display image may be an image for warning against or prohibiting scanning of the display screen 121 with respect to a user of the image display device 100.

In Act 5, when the control unit 200 controls the communication unit 170, the communication unit 170 transmits predetermined information related to the image display device 100 or to a user of the image display device 100 which is stored in the storage unit 150 to the external device 600 (refer to FIG. 9).

FIG. 9 is a diagram which illustrates a state in which the image display device 100 and the external device 600 are connected.

The transmission of information is performed through the network 601. Specifically, the communication unit 170 of the image display device 100 and a communication unit (not illustrated) of the external device 600 are connected, and it is possible for the image display device 100 and the external device 600 to perform transceiving of information therebetween. Here, the external device 600 which can communicate with the image display device 100 is, for example, a personal computer, a server, or the like, which is connected to the image display device 100 so as to communicate therewith using a wired network or a wireless network.

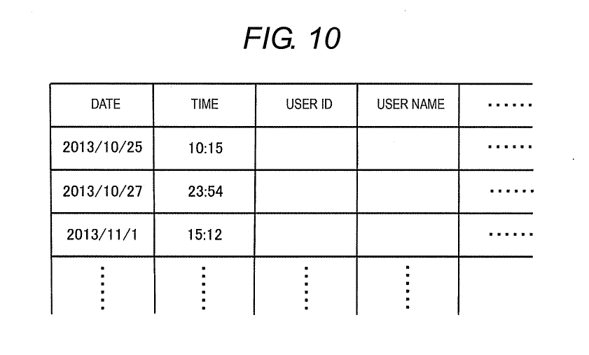

FIG. 10 is a diagram which exemplifies information related to the image display device 100 which is transmitted to the external device 600.

Here, predetermined information related to the image display device 100 or a user of the image display device 100 is, for example, information for specifying a user who has the image display device 100, terminal identification information of the image display device 100, a date and time of executing a scanning prohibiting operation in the image display device 100, or the like. In FIG. 10, a specific example regarding predetermined information related to the image display device 100 or a user of the image display device 100 is illustrated.

In the image display device 100 according to the first embodiment, detecting of the display screen 121 facing downward, and detecting of the fact that the display screen 121 is irradiated with light with brightness of a predetermined threshold value or more are not necessarily performed at the same time, and when it is possible to determine that both conditions are satisfied at the same time as a result, the detecting order thereof is not important.

In addition, in the image display device 100 according to the first embodiment, it is not necessary to include both the direction sensor 180 and the optical sensor 190, and a configuration having only the optical sensor 190 is also possible. In such a case, it is also possible to prevent copying of an image using a camera, by detecting flashing of the camera, for example. It is preferable that brightness of light in the display screen 121 which is detected by the optical sensor 190 at such a time is set to a threshold value of a degree which can detect flashing of the camera.

### Second Embodiment

In a second embodiment, an image display device assumes that an image displayed on a display screen is going to be scanned in a copy machine, or the like, by detecting that the image display device stands still for a predetermined amount of time or more in a state in which the display screen in the image display device faces downward.

When describing the second embodiment, components having the same function as those in the first embodiment are given the same reference numerals, and descriptions thereof will be omitted.

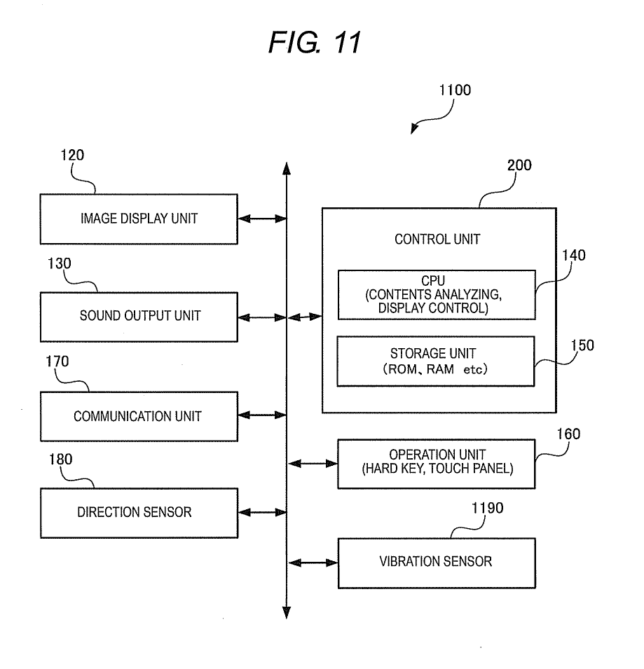

FIG. 11 is a block diagram which illustrates a hardware configuration of an image display device 1100 according to the second embodiment.

The image display device 1100 includes an image display unit 120, a sound output unit 130, a control unit 200 (including CPU 140 and storage unit 150), and an operation unit 160, a communication unit 170, a direction sensor 180, and a vibration sensor 1190.

The vibration sensor 1190 can detect vibration in the image display device 1100. In addition, the vibration sensor 1190 can detect whether or not the image display device 1100 stands still, by detecting vibration in the image display device 1100. As the vibration sensor, it is possible to adopt an acceleration sensor such as a Micro Electro Mechanical Systems (MEMS) sensor which detects the direction of gravitational acceleration, similarly to the direction sensor 180, or an angular velocity sensor such as a gyro sensor. That is, the basic principle of the vibration sensor 1190 is the same as that of the direction sensor 180.

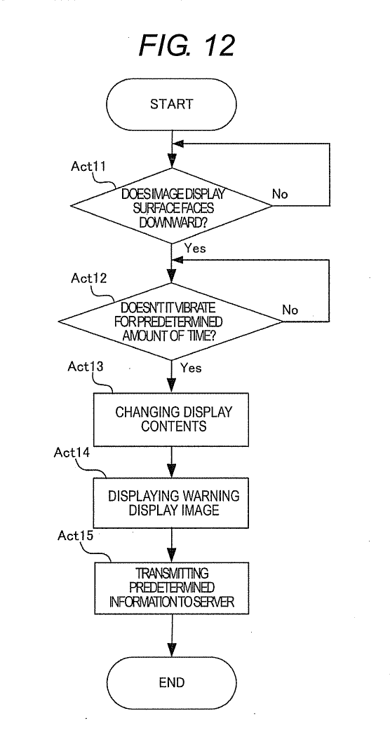

FIG. 12 is a flowchart which illustrates a flow of a scanning prohibiting operation in the image display device 1100.

In Act 11, when the direction sensor 180 detects that a display screen (not illustrated) faces downward, the process proceeds to Act 12 (Yes in Act 11). On the other hand, in Act 11, when the direction sensor 180 detects that a display screen (not illustrated) does not face downward, the process does not proceed to Act 12 (No in Act 11)

In Act 12, when the vibration sensor 1190 detects that the image display device 1100 stands still for a predetermined amount of time or more, the process proceeds to Act 13 (Yes in Act 12). On the other hand, in Act 12, when the vibration sensor 1190 does not detect that the image display device 1100 stands still for a predetermined time or more, the process does not proceed to Act 13 (No in Act 12).

When the display screen of the image display device 1100 according to the second embodiment is going to be scanned in a copy machine, the image display device 1100 is placed on a glass plate in a state of causing the display screen to face downward. In addition, when the display screen of the image display device 1100 is going to be scanned in a copy machine, the image display device 1100 should stand still for a predetermined amount of time. Therefore, in the image display device 1100 according to the second embodiment, it is possible to prevent a display image on the display screen of the image display device 1100 from being scanned, by creating a situation in which the display screen faces downward, and a situation in which the image display device does not vibrate for a predetermined amount of time as determination standards.

The predetermined amount of time during which the image display device 1100 does not vibrate can be set to an amount of time which is necessary for a user to scan an image displayed on the display screen in a copy machine. That is, it is a necessary amount of time from placing the image display device 1100 on a document table glass plate 501 so that the display screen faces downward by a user to completing scanning in an image reading unit 500A.

In Act 13, when the control unit 200 controls the image display unit 120, the image display unit 120 changes display contents displayed on the display screen (not illustrated) to a predetermined display state.

In Act 14, when the control unit 200 controls the image display unit 120, the image display unit 120 changes display contents displayed on the display screen from the predetermined display state to a warning display image.

In Act 15, when the control unit 200 controls the communication unit 170, the communication unit 170 transmits predetermined information related to the image display device 1100, or a user of the image display device 1100 which is stored in the storage unit 150 to the external device 600 (refer to FIG. 9).

In addition, in the second embodiment, in the image display device 1100, detecting in the direction sensor 180, and detecting in the vibration sensor 1190 are not necessarily performed at the same time, thus there is no problem when both conditions are satisfied as a result, and the detecting order thereof is not important.

### Third Embodiment

In an image display device according to a third embodiment, scanning of an image displayed on a display screen is prevented by detecting that the display screen of the image display device faces downward, and a predetermined position of the display screen is pressurized.

When describing the third embodiment, components having the same function as those in the first embodiment are given the same reference numerals, and descriptions thereof will be omitted.

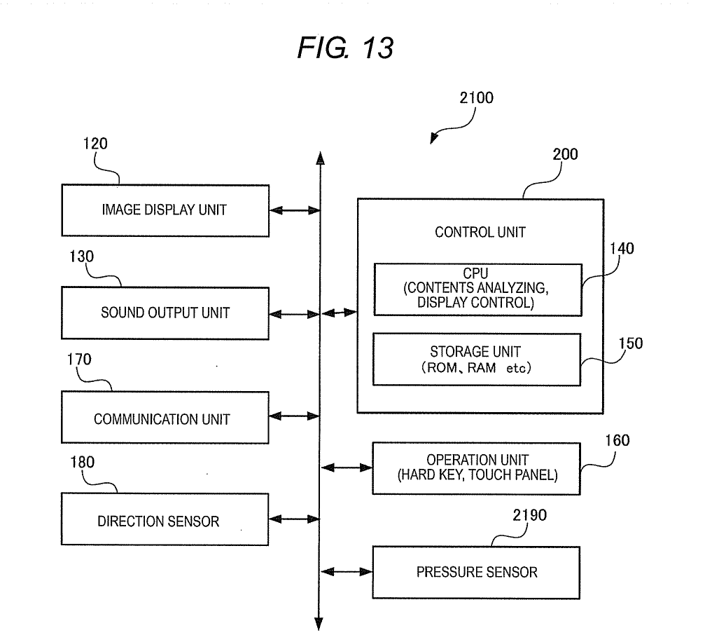

FIG. 13 is a block diagram which illustrates a hardware configuration of an image display device 2100 according to the third embodiment.

The image display device 2100 includes an image display unit 120, a sound output unit 130, a control unit 200 (including CPU 140 and storage unit 150), an operation unit 160, a communication unit 170, a direction sensor 180, and a pressure sensor 2190.

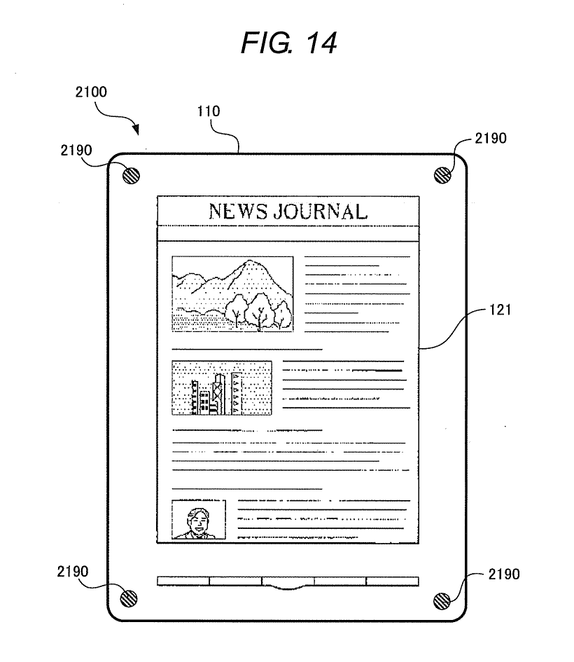

The pressure sensor 2190 can detect a pressure which is applied to a display screen 121 (refer to FIG. 14). The pressure sensor is a device which measures the pressure of gas or liquid using a pressure sensitive element through a diaphragm (stainless steel diaphragm, silicon diaphragm, or the like), converts the pressure into an electric signal, and outputs the signal. The principle of detecting a pressure which is applied to the display screen 121 using the pressure sensor 2190 is not limited to that in the above description, and the pressure sensor may be any sensor which can detect a pressure which is applied to the display screen 121.

When an image displayed on the display screen 121 is desired to be scanned in a copy machine, the display screen 121 is placed on a glass plate of the copy machine by facing downward. A predetermined pressure is applied to the display screen 121 at this time. In the image display device 2100 according to the third embodiment, detection of a pressure applied to the display screen 121 is set to one determination standard for performing a scanning prohibiting operation of a display image. Here, when only a state in which the display screen 121 faces downward is set to the determination standard of the scanning prohibiting operation, display contents displayed on the display screen 121 are changed also in a case in which a user views the display screen 121 while lying on his back, for example. The reason for this is that, when a user views the display screen 121 while lying on his back, for example, it is considered that the display screen 121 faces downward, in general. In this manner, a situation in which display contents which are displayed on the display screen 121 are changed, even when a user views the display screen 121 in a state of lying on his back can be assumed. Accordingly, the image display device 2100 according to the third embodiment is configured by including the pressure sensor 2190, in addition to the direction sensor 180.

FIG. 14 is a diagram which illustrates the appearance of the image display device 2100.

As illustrated in FIG. 14, the pressure sensors 2190 are respectively arranged at corners (four corners) on a plane including the display screen 121 one by one. In the image display device 2100, the scanning prohibiting operation is performed when all of the four pressure sensors 2190 detect pressure. However, the pressure sensor 2190 is not necessarily arranged at the corner of the display screen 121, and a plurality of the pressure sensors may be arranged at the periphery of the display screen 121 on the plane including the display screen 121, for example.

Here, when the scanning prohibiting operation is performed in a case in which a pressure is applied only to at least a part of the display screen 121, as described above, the scanning prohibiting operation is performed also in a case in which a user views the display screen 121 in a state of holding the image display device 2100 while lying on his back.

Accordingly, the pressure sensor 2190 may be arranged at any place when it is possible to detect a pressure so that it is assumed that the display screen 121 is scanned in a copy machine, or the like, and a scanning prohibiting operation is not performed when the display screen is in general use, for example, when a user uses the image display device 2100 by lying on his back.

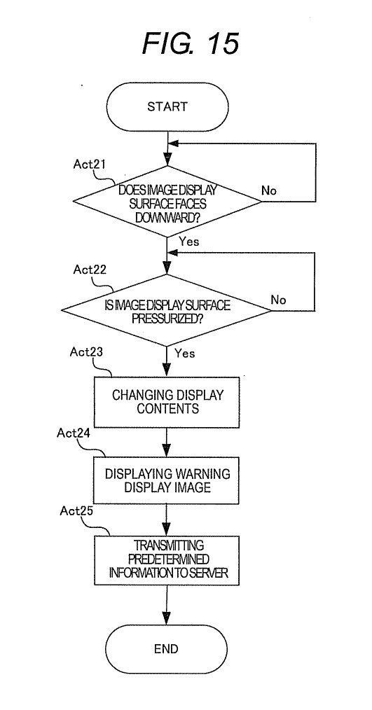

FIG. 15 is a flowchart which illustrates a flow of the scanning prohibiting operation in the image display device 2100.

In Act 21, when the direction sensor 180 detects that the display screen 121 in the image display device 2100 faces downward, the process proceeds to Act 22 (Yes in Act 21). On the other hand, in Act 21, when the direction sensor 180 detects that the display screen 121 does not face downward, the process does not proceed to Act 22 (No in Act 21).

In Act 22, when all of four pressure sensors 2190 which are arranged at the periphery of the image display surface 121 detect pressure, the process proceeds to Act 23 (Yes in Act 22). On the other hand, when even one of the four pressure sensors 2190 does not detect a pressure in Act 22, the process does not proceed to Act 23 (No in Act 22).

In Act 23, when the control unit 200 controls the image display unit 120, the image display unit 120 changes display contents which are displayed on the display screen 121 to a predetermined display state.

In Act 24, when the control unit 200 controls the image display unit 120, the image display unit 120 changes display contents which are displayed on the display screen from the predetermined display state to a warning display image.

In Act 25, when the control unit 200 controls the communication unit 170, the communication unit 170 transmits predetermined information related to the image display device 2100 or a user of the image display device 2100 which is stored in the storage unit 150 to the external device 600 (refer to FIG. 9).

In addition, according to the third embodiment, the image display device 2100 does not necessarily perform detecting in the direction sensor 180, and detecting in the pressure sensor 2190 at the same time, thus there is no problem when both conditions are satisfied as a result, and detecting order thereof is not important.

In addition, according to the third embodiment, the pressure sensor is adopted as a determination standard for confirming that the display screen 121 is scanned; however, it is not necessarily limited to this, and it may be any detection method in which it is possible to assume that a plane including the image display screen is pressed against the glass plate of the copy machine. As such a detection method, for example, a distance sensor may be adopted. The reason for this is that, when it is possible to determine that a distance between the image display surface and the copy machine is 0, it can be assumed that a plane including the image display surface is pressed against the glass plate.

As described above, according to the third embodiment, it is possible to provide an image display device which has the following characteristics of (1) to (5).

(1) An image display device which includes

an image display unit which displays an image on a display screen using a display mechanism which can be optically scanned by a copy machine;

a direction sensor which detects that the display screen faces downward;

a pressure sensor which detects that a pressure of a threshold value or more is applied to a predetermined position on the display screen; and

a control unit which changes display contents of the display screen to a predetermined display state when it is detected that the display screen faces downward in the direction sensor, and it is detected that a pressure of a threshold value or more is applied to a predetermined position of the display screen in the pressure sensor.

(2) The image display device further includes a scanning propriety information obtaining unit which obtains information which is linked to image data of an image as a display target in the image display device, and denotes whether or not the image is an image of which scanning is to be prohibited, in which the control unit changes display contents on the display screen to a predetermined display state with respect to image data in which information denoting that scanning is to be prohibited is obtained in the scanning propriety information obtaining unit, when it is detected that the display screen faces downward in the direction sensor, and it is detected that pressure of a threshold value or more is applied to a predetermined position of the display screen in the pressure sensor.

(3) In the image display device, the control unit displays a predetermined warning display image on the display screen as a change with respect to the predetermined display state.

(4) The image display device further includes a communication unit which transmits predetermined information related to the image display device or a user of the image display device with respect to an external device which can communicate with the image display device, when the change of display state in the control unit is performed.

(5) In the image display device, the display screen displays an image using electronic paper technology.

### Fourth Embodiment

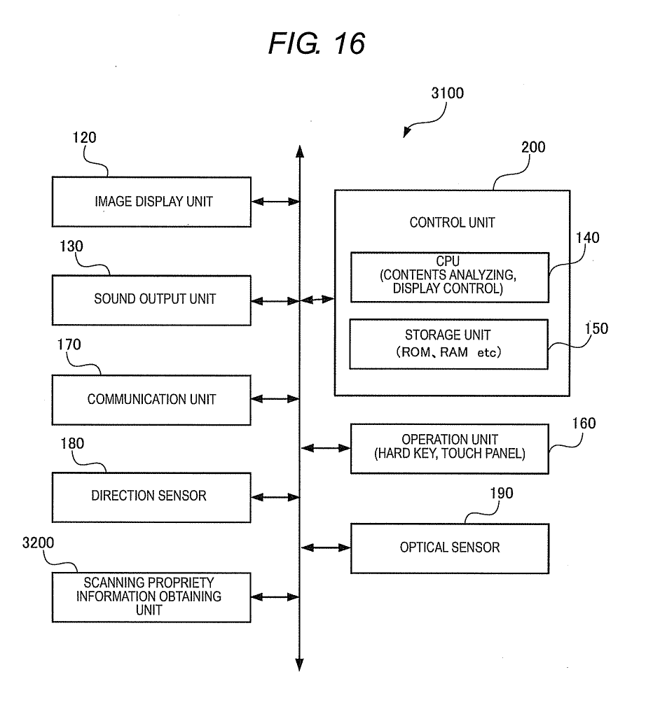

FIG. 16 is a block diagram which illustrates a hardware configuration of an image display device 3100 according to a fourth embodiment.

The image display device 3100 includes an image display unit 120, a sound output unit 130, a control unit 200 (including CPU 140 and storage unit 150), an operation unit 160, a communication unit 170, a direction sensor 180, an optical sensor 190, and a scanning propriety information obtaining unit 3200.

The scanning propriety information obtaining unit 3200 can obtain information (scanning propriety information) denoting whether or not an image displayed on a display screen of the image display device 3100 is an image of which scanning is to be prohibited. As the information denoting whether or not it is an image of which scanning is to be prohibited, for example, there is information denoting protection by a copyright, a flag denoting prohibition of scanning which is set by a creator of the image data, or the like.

The scanning propriety information can be recorded in a header or footer of image data of an image displayed on the display screen, for example. In that case, the scanning propriety information obtaining unit 3200 obtains the scanning propriety information which is recorded in a header or footer of image data.

In addition, as the scanning propriety information, for example, scanning propriety information which is obtained from an external device 600 (refer to FIG. 9) (for example, server) is taken into consideration. In this case, the image display device 3100 transmits image data information to the external device 600 through a network. The external device 600 can determine from the received image data information whether or not image data is image data of which scanning is to be prohibited. After determining scanning propriety, the external device 600 transmits the scanning propriety information to the image display device 3100. In addition, the scanning propriety information obtaining unit 3200 determines whether or not an image displayed on the display screen of the image display device 3100 is an image of which scanning is to be prohibited from the scanning propriety information which is received from the external device 600.

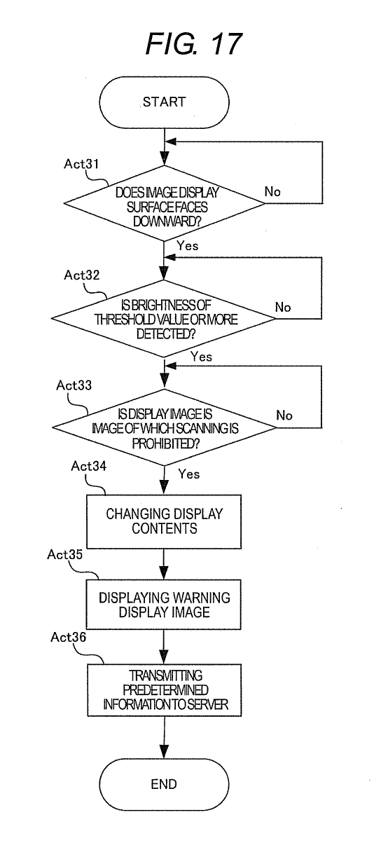

FIG. 17 is a flowchart which illustrates a flow of a scanning prohibiting operation in the image display device 3100 according to the fourth embodiment.

In Act 31, when the direction sensor 180 detects that the display screen of the image display device 3100 faces downward, the process proceeds to Act 32 (Yes in Act 31). On the other hand, in Act 32, when the direction sensor 180 detects that the display screen of the image display device 3100 does not face downward, the process does not proceed to Act 32 (No in Act 31).

In Act 32, when the optical sensor 190 detects brightness of a threshold value or more in the display screen of the image display device 3100, the process proceeds to Act 33 (Yes in Act 32). On the other hand when the optical sensor 190 does not detect brightness of a threshold value or more in the display screen of the image display device 3100, the process does not proceed to Act 33 (No in Act 32).

In Act 33, when the scanning propriety information obtained by the scanning propriety information obtaining unit 3200 is information denoting that an image displayed on the display screen of the image display device 3100 is an image of which scanning is to be prohibited, the process proceeds to Act 34 (Yes in Act 33). On the other hand, in Act 33, when the scanning propriety information obtained by the scanning propriety information obtaining unit 3200 is information denoting that an image displayed on the display screen is an image of which scanning is not to be prohibited, the process does not proceed to Act 34 (No in Act 33).

Here, in Act 33, also in a case in which the scanning propriety information obtaining unit 3200 determines that the scanning propriety information is not included in image data, the process does not proceed to Act 34 (No in Act 33).

In this manner, in the image display device 3100 according to the fourth embodiment, by adopting an algorithm in which whether or not a copy prohibiting operation is to be executed is determined based on information which is linked to image data of an image as a display target, it is possible to prevent the above described copy prohibiting operation from being uselessly executed with respect to image data of which copying is not necessary to be prohibited.

In Act 34, when the control unit 200 controls the image display unit 120, the image display unit 120 changes display contents which are displayed on the display screen (not illustrated) to a predetermined display state.

In Act 35, when the control unit 200 controls the image display unit 120, the image display unit 120 changes display contents which are displayed on the display screen from the predetermined display state to a warning display image.

In Act 36, when the control unit 200 controls the communication unit 170, the communication unit 170 transmits predetermined information related to the image display device 3100 which is stored in the storage unit 150, or a user of the image display device 3100 to the external device 600 (refer to FIG. 9).

In addition, constituent elements in the above described first to fourth embodiments can be arbitrarily combined with each other. For example, the optical sensor in the first embodiment, and the pressure sensor in the third embodiment can be combined.

As described above, according to the technology which is described in the specification, in a mobile image display device, it is possible to provide a technology for prohibiting a confidential document, or the like, which is displayed on a display screen of an image display device from being scanned using a copy machine, or the like.

While certain embodiments have been described, these embodiments have been presented by way of example only, and are not intended to limit the scope of invention. Indeed, the novel apparatus and methods described herein may be embodied in a variety of other forms; furthermore, various omissions, substitutions, and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image display device comprising:
an image display unit which displays an image on a display screen using a display mechanism which can be optically scanned by a copy machine;
a direction sensor which detects that the display screen faces downward;
a vibration sensor which detects a standstill state by detecting vibration; and
a control unit which changes display contents on the display screen to a predetermined display state, when it is detected that the display screen faces downward in the direction sensor, and it is detected that the image display device stands still for a predetermined amount of time in the vibration sensor.

2. The device according to claim 1, further comprising:
a scanning propriety information obtaining unit which obtains information which is linked to image data of an image as a display target in the image display device, and denotes whether or not the image is an image of which scanning is to be prohibited,
wherein the control unit changes display contents on the display screen to a predetermined display state with respect to image data in which information denoting that scanning is to be prohibited is obtained in the scanning propriety information obtaining unit, when it is detected that the display screen faces downward in the direction sensor, and it is detected that the image display device stands still for a predetermined amount of time in the vibration sensor.

3. The device according to claim 1, further comprising:
a communication unit which transmits predetermined information related to the image display device or a user of the image display device with respect to an external device which can communicate with the image display device, when a change in display state in the control unit is performed.

4. The device according to claim 1,
wherein the display screen displays an image using electronic paper technology.

5. An image display method in an image display device which includes an image display unit which displays an image on a display screen using a display mechanism which can be optically scanned by a copy machine, a direction sensor which detects that the display screen faces downward, and a vibration sensor which detects a standstill state by detecting vibration, the method comprising:
changing display contents on the display screen to a predetermined display state, when it is detected that the display screen faces downward in the direction sensor, and it is detected that the image display device stands still for a predetermined amount of time by the vibration sensor.

6. The method according to claim 5,
wherein the image display device further includes
a scanning propriety information obtaining unit which obtains information which is linked to image data of an image as a display target in the image display device, and denotes whether or not the image is an image of which scanning is to be prohibited, and
wherein the method further comprises
changing display contents on the display screen to a predetermined display state with respect to image data in which information denoting that scanning is to be prohibited is obtained in the scanning propriety information obtaining unit, when it is detected that the display screen faces downward in the direction sensor, and it is detected that the image display device stands still for a predetermined amount of time by the vibration sensor.

7. The method according to claim 5,
wherein the image display device further includes
a communication unit which can communicate with an external device, and
wherein the method further comprises
transmitting predetermined information related to the image display device or a user of the image display device to the external device when a change in the display state of the display screen is performed.
